(19) United States
(12) Patent Application Publication
(10) Pub. No.: US 2023/0065912 A1
(43) Pub. Date: Mar. 2, 2023

(54) OFFSHORE HYDROGEN RESERVOIR

(71) Applicant: RWE RENEWABLES GMBH, Essen (DE)

(72) Inventor: MALCOLM LANGHAM, Hamburg (DE)

(21) Appl. No.: 17/759,235

(22) PCT Filed: Jan. 29, 2021
(86) PCT No.: PCT/EP2021/052194

§ 371 Date: Jul. 21, 2022

(30) Foreign Application Priority Data
Feb. 3, 2020 (DE) 10 2020 102 633.1

(51) Int. Cl. B63B 35/44; B63B 39/03

(52) U.S. Cl. CPC B63B 35/44; B63B 39/03; B63B 2035/4486

(57) ABSTRACT

The invention relates to an offshore hydrogen reservoir (1) comprising at least one floating hydrogen tank (2). The offshore hydrogen reservoir (1) allows hydrogen to be stored offshore at low cost and safely, in particular once the hydrogen has been generated using the electrical energy of an offshore wind farm. For this purpose, the offshore hydrogen reservoir (1) comprises a floating hydrogen tank (2) which can be disposed in the water separate from an offshore platform (10) equipped with a hydrogen generator (11).

The invention relates to the offshore storage of hydrogen, in particular hydrogen that has been generated using electrical energy from an offshore wind farm.

Wind energy can be used particularly well in offshore wind farms to generate electrical energy. However, therein it is problematic to conduct the electrical energy to shore. Cable connections to offshore wind farms are elaborate. Therefore, there are offshore wind farms without a cable connection to the mainland. These offshore wind farms generate electrical energy that is used directly on offshore platforms, for example to produce hydrogen. The hydrogen obtained in this way can be brought ashore by ship. However, this makes intermediate storage of the hydrogen necessary. Hydrogen tanks take up much of the limited space on an offshore platform. There is also a significant risk of explosion when storing hydrogen.

It is the object of the present invention, based on the prior art described, to provide a possibility for offshore hydrogen storage that is space-saving and safe.

These objects are solved by the offshore hydrogen storage, the arrangement, and the method according to the independent claims. Further advantageous embodiments are specified in the dependent claims. The features presented in the claims and in the description can be combined with one another in any technologically meaningful way.

According to the invention, an offshore hydrogen storage is presented that comprises at least one floatable hydrogen tank.

The offshore hydrogen storage is designed and configured to be used in the sea, i.e. offshore. The offshore hydrogen storage can also be referred to as a “device for storing hydrogen at a location in the sea.” For example, hydrogen that was generated on an offshore platform can be stored in the offshore hydrogen storage, in particular using electrical energy that was obtained by means of an offshore wind farm. With the floatable hydrogen tank, precious space can be saved on the offshore platform. A hydrogen tank on an offshore platform would require a significant substructure. In comparison, a particularly low constructional complexity is sufficient for the offshore hydrogen storage described. In addition, storing the hydrogen separate from the offshore platform in the floatable hydrogen storage is particularly safe. Should an explosion occur in the hydrogen tank, it can be contained by the seawater.

A floatable hydrogen tank is to be understood as meaning a tank that, on the one hand, is suitable for storing hydrogen and, on the other hand, can float. A steel tank, for example, can store hydrogen. Even if the hydrogen tank preferably does not allow any hydrogen to escape, losses cannot be completely avoided in practice. A hydrogen tank is capable of floating, if it is dimensioned in such a way that it generates enough buoyancy to compensate for its own weight. The buoyant force results from the amount of water displaced by the hydrogen tank, so it depends on how far the hydrogen tank is immersed in the water. The weight of the filled hydrogen tank results on the one hand from its own weight and on the other hand from the weight of the hydrogen in the hydrogen tank. Because hydrogen is very light, the weight of the hydrogen can be almost neglected. For example, the hydrogen tank can have a mass of 40 t and can hold a maximum of 400 kg of hydrogen. The mass of the hydrogen is therefore only around 1% of the total mass of the filled hydrogen tank. Therefore, a hydrogen tank should be considered capable of floating, if it is buoyant when empty, i.e. if its maximum buoyancy (which occurs when the hydrogen tank is completely submerged) is greater than the weight resulting from the mass of the empty hydrogen tank. In this case, the hydrogen tank is submerged in the water to such an extent that the buoyancy and weight are in equilibrium with one another. Buoyancy can be achieved through the choice of dimensions, materials and/or wall thickness. Even if the mass of the hydrogen is comparatively small, it is preferable for the hydrogen tank to be filled only to the extent that it is also capable of floatable when it is filled. The filling of the hydrogen tank can be adjusted via the pressure of the filled hydrogen.

Due to the floatable hydrogen tank, the offshore hydrogen storage is preferably buoyant overall. The hydrogen tank is preferably used as a float, such that additional floats are not required.

It is sufficient for the offshore hydrogen storage to have a single hydrogen tank. In a preferred embodiment, however, the offshore hydrogen storage comprises a multiplicity of floatable hydrogen tanks attached to one another.

The hydrogen tank described above is one of said multiplicity of hydrogen tanks. What was stated above for the one hydrogen tank also applies to the other hydrogen tanks. All of the hydrogen tanks are preferably designed in the same way.

The hydrogen tanks can be attached to each other directly or indirectly. In this way, two adjacent hydrogen tanks can be in direct contact with one another and be attached directly to one another. Alternatively, an intermediate element can be arranged between two adjacent hydrogen tanks, via which the two hydrogen tanks are indirectly connected to one another. It is also not necessary for every hydrogen tank to have a connection to every other hydrogen tank. It is sufficient for the hydrogen tanks to be connected overall. The hydrogen tanks are preferably attached to one another via a frame, in particular made of steel. The hydrogen tanks together with the frame thus form an overall construction that is preferably buoyant overall.

The hydrogen tanks can be attached to each other via the frame, for example, in a port. The offshore hydrogen storage formed in this way can then be towed with a tugboat to the desired position offshore. The offshore hydrogen storage is preferably of modular design in such a way that the individual hydrogen tanks each form a module. The number of hydrogen tanks can easily be changed and adapted to the requirements.

In a further preferred embodiment, the offshore hydrogen storage also has a gangway that is attached to the at least one hydrogen tank.

The gangway is a structure that a worker can walk over, for example, to carry out maintenance work. The gangway is preferably arranged in such a way that it is arranged above the water surface at least for maintenance purposes. Preferably, the gangway is part of the frame via which a multiplicity of the hydrogen tanks is attached to each other. The gangway preferably has a plurality of portions via which all hydrogen tanks can preferably be reached for maintenance purposes.

In a further preferred embodiment, the offshore hydrogen storage is anchored to the seabed.

The offshore hydrogen storage is preferably anchored to the seabed via at least one rope or at least one chain—in particular at least one anchor chain.

In this embodiment, it is preferred that the offshore hydrogen storage floats during normal operation. To prevent it from drifting, the offshore hydrogen storage is anchored to the seabed. For this purpose, at least one cable is provided, which is connected to the offshore hydrogen storage on the one hand and to the seabed on the other hand, for example via an anchor. The rope and the anchor are part of the offshore hydrogen storage.

In a further preferred embodiment of the offshore hydrogen storage, the at least one hydrogen tank is held on a pile that is fastened to the seabed.

The pile can also be referred to as a monopile. The pile is preferably arranged vertically, i.e., perpendicular to the sea surface. Preferably, the pile is dimensioned in such a way that it protrudes above the sea surface. As a result, the at least one hydrogen tank can be attached to the pile in a particularly simple manner. In addition, the pile is also visible when the at least one hydrogen tank is arranged below the sea surface. Thanks to the pile, the offshore hydrogen storage is particularly well secured against drifting. The pile is part of the offshore hydrogen storage. Preferably, the offshore hydrogen storage is buoyant except for the pile.

In a further preferred embodiment of the offshore hydrogen storage, the at least one hydrogen tank can be moved along the pile.

The pile prevents the offshore hydrogen storage from drifting away, but allows the at least one hydrogen tank to move up and down. The at least one hydrogen tank can thus move perpendicular to the water surface. As a result, the pile is relieved to the extent that the weight and the buoyancy of the at least one hydrogen tank do not act on the pile.

In a further preferred embodiment, the offshore hydrogen storage also comprises a ballast tank, it being possible for the at least one hydrogen tank to be moved below the water surface by filling the ballast tank.

The ballast tank is preferably attached to the at least one hydrogen tank, in particular via the frame. The ballast tank can be filled with water. In the simplest case, seawater is used for this purpose. The offshore hydrogen storage preferably has a plurality of ballast tanks. Said ballast tanks are preferably arranged symmetrically, such that the at least one hydrogen tank remains balanced when lowered. Also in general, the at least one hydrogen tank can be kept in balance by filling the ballast tanks differently.

By filling the ballast tanks, the at least one hydrogen tank can be lowered to such an extent that it is arranged completely below the water surface. In this case in particular, the offshore hydrogen storage is particularly safe because the risk of explosion is particularly low and the possible effects of an explosion caused by the seawater can be contained particularly well.

As a further aspect of the invention, an arrangement is presented that comprises:
an offshore platform equipped with a hydrogen generator, and
an offshore hydrogen storage having at least one floatable hydrogen tank.
   The at least one hydrogen tank is connected to the hydrogen generator via at least one line.

The described advantages and features of the offshore hydrogen storage are applicable and transferrable to the arrangement, and vice versa. The offshore hydrogen storage of the arrangement is preferably configured as described.

Hydrogen can be generated with the hydrogen generator on the offshore platform, in particular using electrical energy that is generated with an offshore wind farm. The hydrogen formed in this way can be stored in the offshore hydrogen storage. This is particularly possible in the gaseous state. The at least one hydrogen tank is connected to the hydrogen generator via the at least one line. One line is preferably laid at least in part on the seabed. This can prevent the line from being damaged, for example, by a ship sailing between the offshore platform and the offshore hydrogen storage.

The stored hydrogen can be transported away by ship, for example. Alternatively, the stored hydrogen can also be liquefied on the offshore platform and/or used to manufacture other products such as LOHC. The liquid hydrogen or the product obtained can then be transported away by ship.

As a further aspect, a method is presented in which hydrogen is stored offshore in at least one floatable hydrogen tank.

The described advantages and features of the offshore hydrogen storage and the arrangement can be applied and transferred to the method and vice versa. The offshore hydrogen storage and the arrangement are preferably intended and configured for operation in accordance with the method. The method is preferably carried out with the offshore hydrogen storage described, in particular in connection with the arrangement described.

In a preferred embodiment of the method, the at least one hydrogen tank is kept below the water surface during normal operation and is at least in part raised above the water surface for maintenance purposes.

It is sufficient for a respective upper portion of the at least one hydrogen tank to be raised above the water surface for maintenance purposes.

The invention is explained in more detail below with reference to the figures. The figures show particularly preferred embodiments to which the invention is not limited, however. The figures and the proportions shown therein are only schematic. In the drawings:

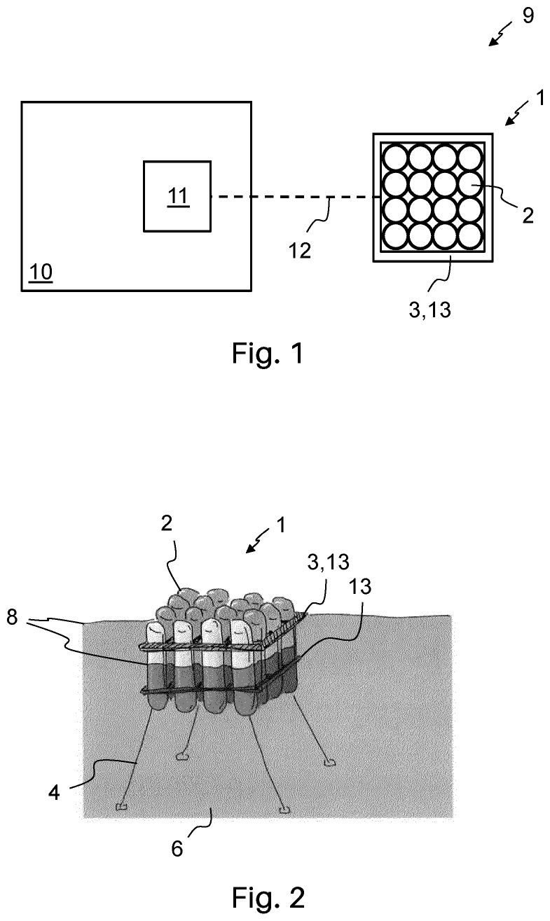

FIG. 1: is a top view of an arrangement according to the invention,

FIG. 2: is a perspective view of a first embodiment of an offshore hydrogen storage for the arrangement of FIG. 1,

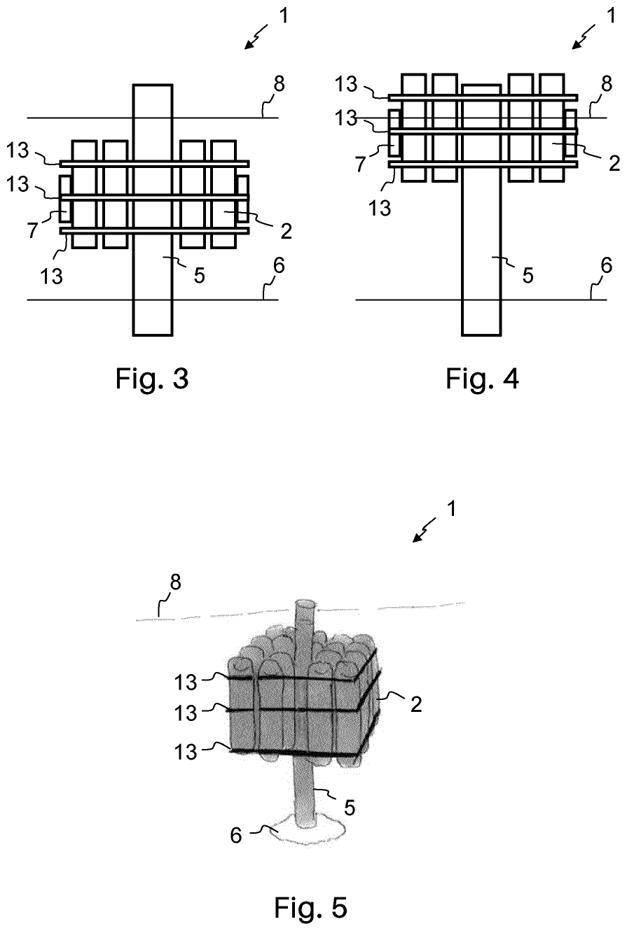

FIG. 3: is a side view of a second embodiment of an offshore hydrogen storage for the arrangement of FIG. 1 during normal operation,

FIG. 4: is a side view of the offshore hydrogen storage of FIG. 3 in a state for maintenance purposes, and

FIG. 5: is a perspective view of the offshore hydrogen storage of FIGS. 3 and 4 during normal operation.

FIG. 1 shows an arrangement 9 having an offshore platform 10 and an offshore hydrogen storage 1. The offshore platform 10 has a hydrogen generator 11 with which hydrogen can be generated, in particular using electrical energy from an offshore wind farm. This hydrogen, in particular as a gas, can be fed to the offshore hydrogen storage 1 via a line 12 in order to be stored in the offshore hydrogen storage 1. For this purpose, the offshore hydrogen storage 1 has multiple floatable hydrogen tanks 2. In the shown embodiment, 4×4, i.e. 16, hydrogen tanks 2 are provided. These are attached to one another via a frame 13. The part of the frame 13 that can be seen in FIG. 1 is designed as a gangway 3. Via the gangway 3, for example, maintenance work can be carried out.

FIG. 2 shows a first embodiment of an offshore hydrogen storage 1 for the arrangement 9 of FIG. 1. The 16 hydrogen tanks 2 can be seen that are arranged parlay below and partly above the water surface 8. The hydrogen tanks 2 thus float. This is possible because the hydrogen tanks 2 are dimensioned in such a way that their buoyancy just compensates for the weight. In order to prevent the hydrogen tanks 2 from drifting off, they are anchored to the seabed 6 by means of ropes 4, in this case four by way of example. The gangway 3 and the other parts of the frame 13 are also shown.

FIGS. 3 to 5 show a second embodiment of an offshore hydrogen storage 1 for the arrangement 9 of FIG. 1. Therein, the hydrogen tanks 2 are held on a pile 5 that is fixed to the seabed 6. The hydrogen tanks 2 can be moved along the pile 5, i.e., up and down. Therein, they are guided by the pile 5. The position of the hydrogen tanks 2 on the pile 5 can be adjusted by filling and emptying ballast tanks 7. It is thus possible for the hydrogen tanks 2 to be kept below the water surface 8 during normal operation when the ballast tanks 7 are filled (FIG. 3) and to be raised at least in part above the water surface 8 for maintenance purposes. In this embodiment, too, the hydrogen tanks 2 are attached to one another via a frame 13. Said frame is not designed as a gangway, which however would also be possible in this embodiment.

The offshore hydrogen storage 1 allows hydrogen to be stored offshore at low cost and safely, in particular once the hydrogen has been generated using the electrical energy of an offshore wind farm. For this purpose, the offshore hydrogen storage 1 comprises a floatable hydrogen tank 2 that can be disposed in the water separate from an offshore platform 10 equipped with a hydrogen generator 11.

### LIST OF REFERENCE SIGNS

1 offshore hydrogen storage
2 hydrogen tank
3 gangway
4 rope
5 pile
6 seabed
7 ballast tank
8 water surface
9 arrangement
10 offshore platform
11 hydrogen generator
12 line
13 frame

1. Offshore hydrogen storage (1) comprising at least one floatable hydrogen tank (2).

2. Offshore hydrogen storage (1) according to claim 1, comprising a multiplicity of floatable hydrogen tanks (2) attached to one another.

3. Offshore hydrogen storage (1) according to any of the preceding claims, further comprising a gangway (3) that is attached to the at least one hydrogen tank (2).

4. Offshore hydrogen storage (1) according to any of the preceding claims, wherein the offshore hydrogen storage (1) is anchored to the seabed (6).

5. Offshore hydrogen storage (1) according to any of claims 1 to 3, wherein the at least one hydrogen tank (2) is held on a pile (5) that is fixed to the seabed (6).

6. Offshore hydrogen storage (1) according to claim 5, wherein the at least one hydrogen tank (2) is movable along the pile (5).

7. Offshore hydrogen storage (1) according to any of the preceding claims, further comprising a ballast tank (7), wherein the at least one hydrogen tank (2) can be moved below the water surface (8) by filling the ballast tank (7).

8. Arrangement (9) comprising
an offshore platform (10) equipped with a hydrogen generator (11), and
an offshore hydrogen storage (12) having at least one floatable hydrogen tank (2),
wherein the at least one hydrogen tank (2) is connected to the hydrogen generator (11) via a line (12).

9. Method in which hydrogen is stored offshore in at least one floatable hydrogen tank (2).

10. Method according to claim 9, wherein the at least one hydrogen tank (2) is kept below the water surface (8) during normal operation and is at least in part raised above the water surface (8) for maintenance purposes.
